(19) United States
(12) Patent Application Publication
(10) Pub. No.: US 2012/0166926 A1
(43) Pub. Date: Jun. 28, 2012

(54) HYPERLINK DISPLAY METHOD BASED ON VISIT HISTORY ACCUMULATION

(75) Inventors: Ji Yong KIM, Daejeon (KR); Hyeon Jin Kim, Daejeon (KR); Jin Mee Kim, Daejeon (KR); Dong Hwan Son, Daejeon (KR); Sung Ho Im, Daejeon (KR); Shin Young Ahn, Daejeon (KR); Kyoung Park, Daejeon (KR); Seung Jo Bae, Daejeon (KR); Wan Choi, Daejeon (KR)

(73) Assignee: Electronics and Telecommunications Research Institute, Daejeon (KR)

(21) Appl. No.: 13/284,317

(22) Filed: Oct. 28, 2011

(30) Foreign Application Priority Data
Dec. 22, 2010 (KR) 10-2010-0132908

(51) Int. Cl. G06F 17/00

(52) U.S. Cl. 715/207; 715/205

(57) ABSTRACT

Provided is a hyperlink display method based on a visit history accumulation, which is capable of providing search convenience between web documents by providing a self-updating hyperlink through accumulation of a visit history. The hyperlink display method includes displaying a plurality of hyperlink included in a web document when the web document is selected, recording a weight value of a selected hyperlink when any one of the plurality of hyperlinks is selected, and displaying the weight value of the selected hyperlink on the web document.

### CROSS-REFERENCE TO RELATED APPLICATIONS

The present application claims priority to Korean patent application number 10-2010-0132908, filed on Dec. 22, 2010, which is incorporated by reference in its entirety.

### BACKGROUND OF THE INVENTION

The present invention relates to a hyperlink display method based on a visit history accumulation, and more particularly, to a hyperlink display method capable of providing search convenience between web documents by providing a self-updating hyperlink through accumulation of a visit history.

Generally, Hyperlink is a technique which can move directly to another web document of the same domain or other domains when selecting a letter, an image, or the like in a web document. A hyperlink stores the URL of a target web document in the letter, the image, or the like, and therefore, when a user selects it, a browser moves to the relevant site according to the target URL.

The hyperlink is a basic, essential characteristic of the web, and can be implemented in most markup languages which are used to compose web documents. Through the hyperlink, users can grasp information by moving freely to other web documents from a specific web document.

Meanwhile, there are various techniques that help users to find out a desired data or a desired web document due to a sudden massive increase in data. Especially, search engines analyze hit rates of users, and display search results weighting according to priorities, thus making it possible to access desired information in a short time and with less steps.

Typical techniques present other guides to users through a method that draws a weight value graph comparing similarities between web documents and then uses the graph for search, a method that analyzes hit rates and then assigns priorities according to search words, or the like.

However, the typical techniques have a limitation that specific search engines or programs should be used, and do not express fully an active living network.

The above-described technology is the background which helps to understand the present invention, but does not mean the well-known prior art in the art to which the present invention pertains.

### SUMMARY OF THE INVENTION

Embodiments of the present invention are directed to a hyperlink display method based on a visit history accumulation, which expresses original web documents reflecting user actions.

Herein, directly reflecting user actions on web documents means that web documents are updated without being restricted to initial formats and contents by implementing an active living network. Therefore, update in the present embodiment is not to passively be changed by original authors, but to update according to rules actively analyzing visitor actions.

Embodiments of the present invention are also directed to a hyperlink display method based on a visit history accumulation, which enables a web document to directly modify its hyperlinks by itself and to implement an active living web space in order to be helpful in performing navigation and search between web documents.

Embodiments of the present invention are also directed to a hyperlink display method based on a visit history accumulation, which is capable of providing search convenience between web documents by providing a self-updating hyperlink through accumulation of a visit history.

In one embodiment, a hyperlink display method based on a visit history accumulation, include: displaying a plurality of hyperlink included in a web document if the web document is selected; recording a weight value of a selected hyperlink if any one of the plurality of hyperlinks is selected; and displaying the weight value of the selected hyperlink on the web document.

In the present invention, the recording of the weight value may include recording the weight value as an attribute of a meta-tag of the web document or the selected hyperlink.

In the present invention, the recording of the weight value may include recording the number of moves to another web document through the selected hyperlink.

In the present invention, the displaying of the weight value may include displaying the weight value on the web document if the weight value of the selected hyperlink is greater than a threshold.

In the present invention, the displaying of the weight value may include displaying by changing an appearance attribute of the selected hyperlink or an appearance attribute of other hyperlinks.

The threshold used in the present invention may be varied according to the number of visitors over time of the web document.

In the present invention, the displaying of the weight value may include displaying the weight value of the selected hyperlink to meet a user requirement analyzing the meta-tag for the weight value of the selected hyperlink.

### BRIEF DESCRIPTION OF THE DRAWINGS

FIG. 1 illustrates web documents which have applied a hyperlink display method based on a visit history accumulation according to an embodiment of the present invention.

FIG. 2 illustrates a hyperlink display method based on a visit history accumulation according to an embodiment of the present invention.

### DESCRIPTION OF SPECIFIC EMBODIMENTS

Hereinafter, a hyperlink display method based on a visit history accumulation in accordance with the present invention will be described in detail through embodiments. The embodiments described herein are merely provided to illustrate the present invention. Thus the scope of the present invention shall not be restricted or limited by the embodiments.

Herein, the drawings may be exaggerated in thicknesses of lines or sizes of components for the sake of convenience and clarity in description. Furthermore, terms used herein are defined in consideration of functions in the present invention and may be varied according to the custom or intention of users or operators. Thus, definition of such terms should be determined according to overall disclosures set forth herein.

Hereinafter, embodiments in accordance with the present invention will be described in detail with reference to the accompanying drawings.

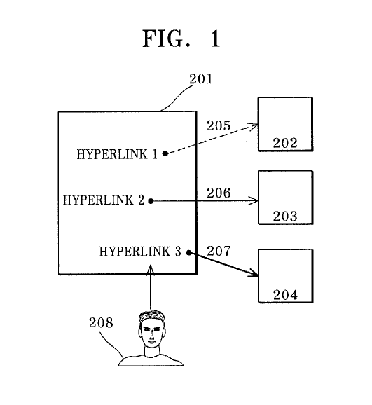

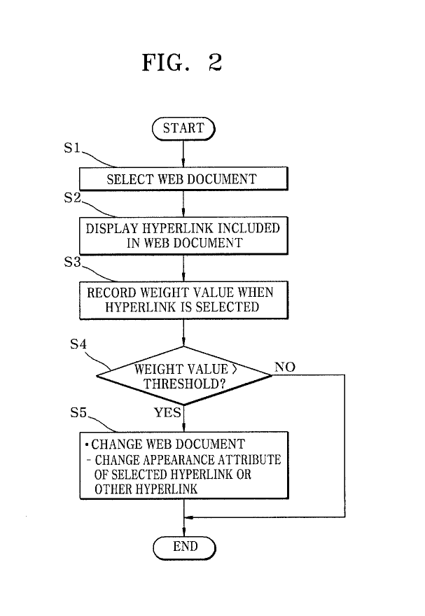

FIG. 1 illustrates web documents which have applied a hyperlink display method based on a visit history accumulation according to an embodiment of the present invention, and FIG. 2 illustrates a hyperlink display method based on a visit history accumulation according to an embodiment of the present invention.

Referring to FIGS. 1 and 2, a web document 201 modifies its hyperlink weight values according to hyperlinks through which a visitor moves to other web documents 202-204.

As illustrated in FIG. 1, each hyperlink has a weight value like 205-207.

For example, if a visitor 208 visits a web document 204 by clicking on the third hyperlink 207, the weight value of the third hyperlink 207 increases.

This technique is applied to a search engine in order to show searched pages of users. However, it is originally not to change web documents, but merely to show priorities according to search words in order to provide user convenience.

In the present invention, the web document 201 at which a user is looking is directly updated according to visitor actions.

An operation in which weight values of hyperlinks are updated will be described below.

As described in FIG. 2, it starts with the situation at which the web document 201 is visited.

First, in operation S1 and S2, if the web document 201 is selected, plural hyperlinks 205-207 included in the web document 201 are displayed.

Thereafter, in operation S3, if any one of the hyperlinks 205-207 is selected, a weight value of the selected hyperlink is recorded.

Since recording like this does not have any real effect, the weight values may be inserted into meta-tags or the hyperlinks 205-207 as an attribute.

A recorded content expresses the number of times visitors have moved to other web documents 202-204 through the hyperlink 205-207.

For example, when the visitor 208 looking at the web document 201 selects the third hyperlink 207, the visitor's click is feedback to a web server of an original document through JavaScript or another web programming.

In operation S5, the weight value of the third hyperlink 207 is displayed on the web document 201.

On the basis of information accumulated through the above operation, the hyperlinks 205-207 within the web document 201 are expressed so that they may look different. There may be two expression techniques.

As illustrated in FIG. 2, one technique directly changes the web document 201 when the recorded weight values are greater than a threshold.

For example, by changing an appearance attribute value (e.g. font size, or the like) of the hyperlinks 205-207, it is possible that the hyperlinks 205-207 are displayed to look different in any web browser. In the present embodiment, an appearance attribute of the selected third hyperlink 207, or an appearance attribute of the other hyperlinks 205 and 206 is changed to be displayed.

In the other technique, a web browser analyzes meta-tags and then expresses the weight values of the hyperlinks 205-207 to meet user requirements. This technique has the merit of suitably expressing according to user preference.

In the present invention, the threshold is not a specified value, but is dynamically determined through a computational operation. That is because the number of visitors increases with the lapse of time, and thus an efficient management technique of the threshold is needed.

As described above, according to the present invention, it is possible for users to search web documents without using specific search engines or programs by directly modifying web documents on the basis of web document access history.

Also, according to the present invention, it is possible to efficiently improve entire web environment by enabling general web documents to evolve through self-updating.

Also, according to the present invention, it is possible to intelligently change web environment through various other applications. That is because web documents and hyperlinks is not regarded as static data resources, but is regarded as a living cell of the network which is capable of growing up and evolving by itself.

While the present invention has been described with respect to the specific embodiments, it will be apparent to those skilled in the art that various changes and modifications may be made without departing from the spirit and scope of the invention as defined in the following claims. Thus, the scope of the present invention is to be determined by the following claims and their equivalents.

What is claimed is:

1. A hyperlink display method based on a visit history accumulation, comprising:
displaying a plurality of hyperlink included in a web document when the web document is selected;
recording a weight value of a selected hyperlink when any one of the plurality of hyperlinks is selected; and
displaying the weight value of the selected hyperlink on the web document.

2. The hyperlink display method of claim 1, wherein the recording of the weight value comprises recording the weight value as an attribute of a meta-tag of the web document or the selected hyperlink.

3. The hyperlink display method of claim 2, wherein the recording of the weight value comprises recording the number of moves to another web document through the selected hyperlink.

4. The hyperlink display method of claim 1, wherein the displaying of the weight value comprises displaying the weight value on the web document when the weight value of the selected hyperlink is greater than a threshold.

5. The hyperlink display method of claim 4, wherein the displaying of the weight value comprises displaying by changing an appearance attribute of the selected hyperlink or an appearance attribute of other hyperlinks.

6. The hyperlink display method of claim 4, wherein the threshold is varied according to the number of visitors over time of the web document.

7. The hyperlink display method of claim 1, wherein the displaying of the weight value comprises displaying the weight value of the selected hyperlink to meet a user requirement analyzing the meta-tag for the weight value of the selected hyperlink.
